(19) United States
(12) Patent Application Publication
(10) Pub. No.: US 2007/0192404 A1
(43) Pub. Date: Aug. 16, 2007

(54) Anonymous integrity of transmitted data

(75) Inventor: Holger School, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/599,190

(22) PCT Filed: Mar. 15, 2005
(86) PCT No.: PCT/IB05/50903

§ 371 Date: Sep. 22, 2006

(30) Foreign Application Priority Data
Mar. 23, 2004 (EP) 04101183.4

(51) Int. Cl. G06F 15/16

(52) U.S. Cl. 709/203

(57) ABSTRACT

The present invention relates to a method of ensuring integrity when transmitting data from a transmitting device to a receiving device, wherein said method comprises the step of adding a token to said data before transmitting said data. Thereby, by comparing transmitter tokens, the receiver can cancel out unwanted multiple copies of the same message originating from the same transmitting device. This can be performed without the sender knowing the real identity of the user operating the transmitting device. The token could e.g. be a random number, and if the chosen random number interval is large, the probability for other transmitting devices to create the same number is minimized.

The present invention relates to a method of ensuring integrity when transmitting data from a transmitting device to a receiving device.

The ongoing “digitalization” of many aspects or our lives implies a strongly increasing amount of open or hidden electronic data exchange. In many cases, the users do not want to disclose their behavioural patterns to the outside world.

People are very sensitive to giving private information or meta-information about their behavioural pattern away to the outside world. Nevertheless, many near-future scenarios foresee mobile devices with short range ad-hoc networking capabilities that people carry with them when they are on the move. From such short-range networking possibilities a wealth of application ideas arise, some of which deal with the exchange of data with unknown and/or unrelated people (e.g. for exchange of restaurant recommendations and the like). Whereas the user is typically interested in sharing particular information, he is also interested in maintaining his anonymity. Furthermore, he wants to ensure that nobody can falsely claim another one's identity. Some of the important issues when discussing anonymity and integrity are:
No one should be able to collect messages transmitted by a user and use them to derive a profile for a certain user or the user's virtual identity,
Any recipient of a message can check whether the sender has an asserted property in order to be able to evaluate the transmitted message. This includes in particular identity properties, such as alias ‘names’ or job titles.
Any recipient of a message can check whether the received message was changed from the sender's original intent.
No one can claim to be someone else.

There are methods known to electronically sign e-mails, so that the recipient can ensure the integrity of the transmitted data such as messages together with authenticating the asserted sender. These are based on known identities, e.g. that you need to have a public key of the recipient. Some of them have been adopted for use in ad-hoc networking situations. Additionally, there are known systems that allow data exchange in complete anonymity. But up to now there are no systems known that allow authenticating who and what in a messaging system without revealing true or virtual identities e.g. by tracing the identity.

It is therefore an object to provide a solution to the above mentioned problem.

This is obtained by a method of ensuring integrity when transmitting data from a transmitting device to a receiving device, wherein said method comprises the step of adding a transmitter token to said data before transmitting said data, said transmitter token being unique for said transmitting device. Thereby, by comparing transmitter tokens the receiver can cancel out unwanted multiple copies of the same message originating from the same transmitting device. This can be performed without the sender knowing the real identity of the user operating the transmitting device. The token could e.g. be a random number, and if the chosen random number interval is large, the probability for other transmitting de-vices to create the same number is minimized.

In an embodiment said transmitter token comprises protected information, whereby information in said token can only be read by a central service, said information in said token comprising,
a transmitting device ID uniquely identifying the transmitting device,
a random text.

Because of the random text, the token becomes unique for each transmitting device, whereby the receiver can cancel out unwanted multiple copies of the same message originating from the same transmitting device. Further, the receiver can forward the token to the central service, which can read the information in the token and confirm the ID of the transmitter to the receiver.

In an embodiment the step of protecting said information in said token is performed by encrypting it using an encryption algorithm only known by the transmitting device and by said central server. This could e.g. be based on using a PGP system, where the transmitter encrypts the information in the token using the public key of the central service.

In an embodiment the information in said token further comprises,
a data generated hash value to be used for ensuring that the transmitted data corresponds to the data received by said receiving device.

Thereby the receiver can forward the token to the central service, which can read the information in the token and confirm whether the received data is really the data that was transmitted by the transmitting device or whether the data was changed on its way to the receiver.

In a specific embodiment said information further comprises,
a property key indicating the property of the user using the transmitting device.

Thereby the receiver can forward the token to the central service, which can read the information in the token and confirm whether the user has the asserted property.

In an embodiment said information further comprises,
a secret only known by said transmitting device and said central service.

Thereby it is ensured that nobody else but the transmitting device is able to generate the specific token.

The invention further relates to a computer readable medium having stored therein instructions for causing a processing unit in a transmitting device to execute the method described above.

In the following preferred embodiments of the invention will be described referring to the figures, where

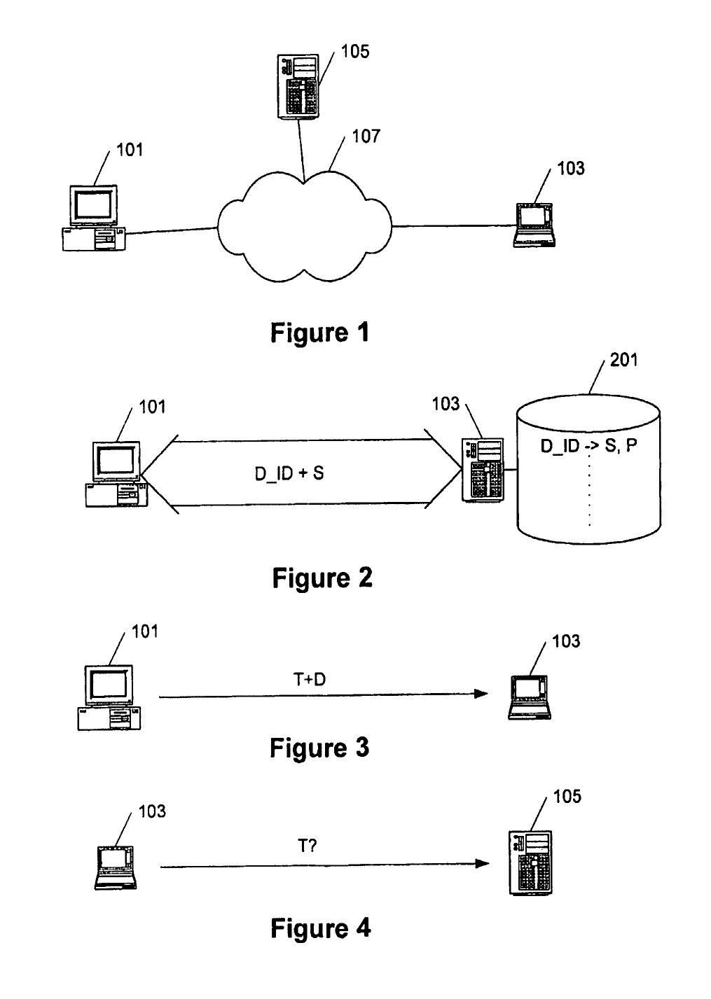

FIG. 1 illustrates a system for ensuring data integrity,

FIG. 2 illustrates the data exchange between the transmitting device and the central server,

FIG. 3 illustrates the transmitting device transmitting data to the receiving device,

FIG. 4 illustrates the receiving device checking integrity of data received from the transmitting device by using the central server,

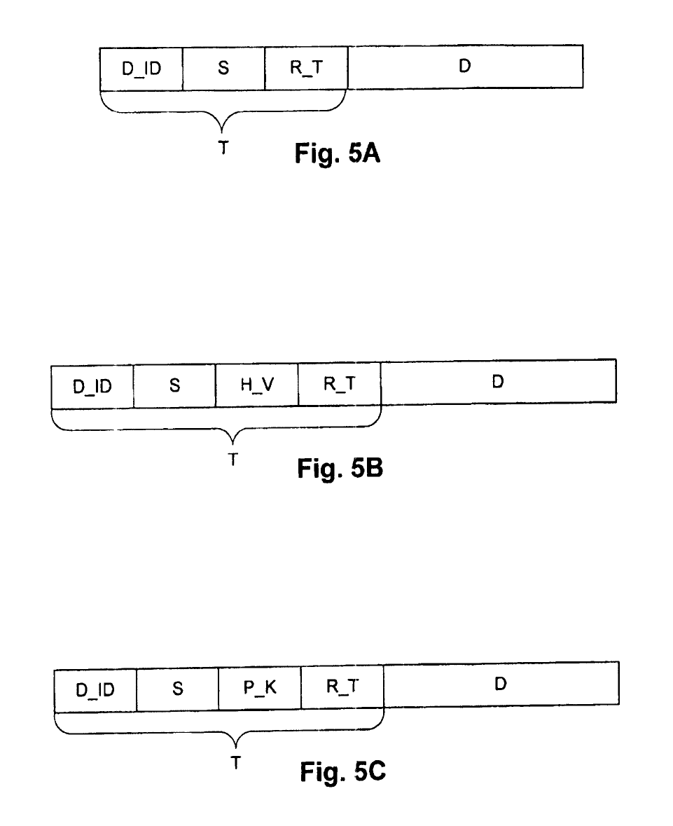

FIG. 5A-C illustrate different embodiments of tokens to be part of the transmitted data,

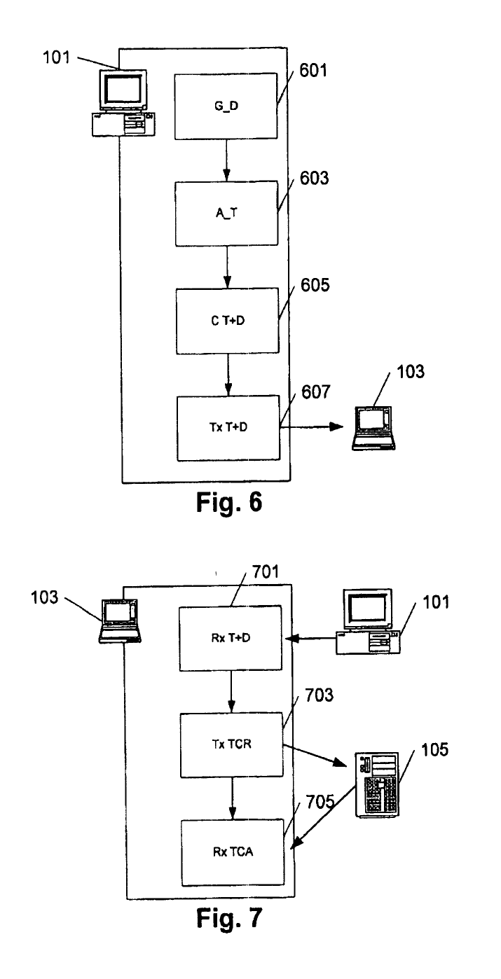

FIG. 6 illustrates the method of transmitting data from a transmitting device to a receiving device,

FIG. 7 illustrates the method of checking integrity of data received from the transmitting device.

In FIG. 1 a system for ensuring data integrity according to the present invention is illustrated. The system comprises a transmitting device 101, a receiving device 103 and a central server 105 all being able to communicate together via a communication channel, which in this specific example is illustrated as the Internet 107.

The central server could also be referred to as being similar to a trust centre, though according to the present invention, the central server does not know about the real life identity of a user. Upon purchase of a transmitting device 101, each user is given a “secret” (such as e.g. a PIN code) that is only known to him and the central server 105. The central server 105 knows which device ID (D_ID) corresponds to which “secret” (S), but has no information about the real life identity of the user.

As also illustrated in FIG. 2, the central server 105 stores in a database 201 a linking between the device ID and the corresponding secret, this linking being shared with the transmitting device 101. As illustrated, the database 201 comprises linking between a number of device ID's and a corresponding secret relating to different transmitting devices. The secret may be a PIN or a specific pass phrase. If the system is used in a context where the central server and the client devices communicate on public key encryption, then no specific key is required. A particular transmitting device simply signs the token with its private key, so that anybody who knows the public key of the device can check that this device created the token. But for authentication, it is still essential to correlate the asserted device ID with the trustingly matching public key, only being possible by using the central server who knows the pairing of the Device ID and the key/secret.

Authentication of data such as messages is then based upon tokens that are individually created for each transmitted message that are transmitted to another device. This is illustrated in FIG. 3, where data (D) is transmitted from a transmitting device 101 to a receiving device 103 together with the token (T).

The receiving device 103 can then, as illustrated in FIG. 4, use the token and the information in the token to authenticate and gain information on the sender of the data by requesting it (T?) from the central server 105.

Furthermore, relaying devices (i.e. devices distributing the original message) can also add their tokens, so the recipient can derive information about how many hops the message has passed, or how interesting the message was considered, etc. Therefore, a message received based on the present invention could comprise the message body, the sender token and one or more relayer tokens.

FIG. 5A-C illustrate different embodiments of tokens to be part of the transmitted data.

In FIG. 5A the content in a token is illustrated that can be used to determine the originator of multiple received messages all having the same message body. The recipient can identify the original sender by the leading token. If the token only comprised the Device ID, or a simple function of it, any recipient could create a profile of the sender. This could be achieved by collecting meta-information for this particular ID (such as when and where messages by that sender have been received)—which might not be in the interest of the sender. Therefore, as shown in FIG. 5A, the token comprises an encryption information performed with the public key of the central server, whereby the information in the token is only readable by the central server. The information comprises the Device ID (D_ID), a secret (S) and a random text (R_T). This encrypted data, together with technical network data, build the token that is distributed with the data (D) also referred to as the message body. No one else than the original sender can create this token because of the secret, but this feature can be optional for uncritical messages. The random text (R_T) ensures that even the encrypted text and thereby the token vary from message to message. So each message has a unique identification token that does not allow any conclusions about the sender's original ID. The recipients can cancel out unwanted multiple copies of the same message by the same sender even without needing to contact the central server.

In FIG. 5B an embodiment of a, token is illustrated that can be used to ensure that a message body really belongs to the asserted sender, and to ensure that the message body is an unchanged version of the true sender. In this case, there are several ways to handle the recipients' request from a protocols point of view. It could be obligatory for a specific class of messages to include the relevant data right from the beginning. Or it could be possible to reply to an incoming message with a specific request to the sender to authenticate the message. But especially in ad-hoc networking scenarios, the sender might not be directly reachable or even completely unavailable at the time of request. Therefore, it might be advantageous to include the relevant crosscheck information. The sender derives a hash value or a check sum according to a generally agreed procedure for the message to be transmitted. Then he generates the token as illustrated in FIG. 5B by encrypting the information comprising a device ID (D_ID), a secret (S), the hash value (H_V) and the random text (R_T). Again, the secret can be optional, but it allows verifying the sender upon request. Any recipient that wants to ensure the integrity of the message text can calculate the corresponding hash value or checksum from the received message. Handling this, together with the message token, to the central server allows the instance to verify whether the hash value that was encrypted (and could not be changed by anybody other than the true sender if the secret is included!) coincides with the independently derived one. So, the recipient knows two things:
the message body was unchanged, and
the message was really sent by the asserted sender.

Again, no recipient can correlate this message to previous messages if the random text is included (the hash value might be sufficient to change the message token). Furthermore, the central instance has no particular knowledge about the content of the message as it only receives hash values or checksums.

In FIG. 5C an embodiment of a token is illustrated that can be used to ensure that a sender really has an asserted property. In some cases it might be important or at least interesting to know whether the sender of a message has the—or at least some—authority to send it. A simple example would be based on experience points: Each device owner collects experience points on certain subjects. Whenever a recipient encounters a message on such a subject, he might also be interested in the level of experience of the sender. Other examples are based on scenarios where only particular users/devices may send certain kinds of messages. In these examples, it is possible with the method of the present invention to verify that a sender really has an asserted property, whenever these properties are known to the central server. In this case, the sender creates a token comprising a device ID (D_ID), a secret (S), a property key (P_K) and the random text (R_T). Along with the message body (D) and the token the sender indicates the specific property he claims to have (using a property key (P_K) being an indicator of the particular property. Again, any recipient can verify with the central instance that the sender of a message has the asserted property, without obtaining any information about the sender's true or virtual identity.

FIG. 6 illustrates the method of transmitting data from a transmitting device to a receiving device. Initially in 601 the transmitting device 101 generates the data to be sent. Such data could e.g. be a message in a mail program. Next in 603 a token is generated, e.g. by combining the information mentioned in either FIGS. 5A, 5B or 5C and encrypting it using the public key of the central server, whereby only the central server can read the information in the token. Next, in 605 the generated token (T) and the generated data (D) are combined and in 607, and this is transmitted to the receiving device 103.

In FIG. 7 the method of checking integrity of data received at the receiving device from the transmitting device is illustrated. The receiving device 103 receives 701 the generated token (T) and the generated data (D) from the transmitting device 101. Next, in 703 the receiving device can optionally forward the token to the central server 105 including a check request (TCR). As described in connection with FIG. 5A-5C and in 705 the receiving device receives an authentication response (TCA) from the central server 105.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of ensuring integrity when transmitting data from a transmitting device to a receiving device, comprising adding a transmitter token to said data before transmitting said data, said transmitter token being unique for said transmitting device.

2. A method according to claim 1, wherein said transmitter token comprises protected information, whereby information in said token is only readable by a central service, said information in said token comprising,
a transmitting device ID uniquely identifying the transmitting device,
a random text.

3. A method according to claim 2, wherein protecting said information in said token is performed by encrypting it using an encryption algorithm only known by the transmitting device and by said central server.

4. A method according to claim 2, wherein said information further comprises,
a data generated hash value to be used for ensuring that the transmitted data corresponds to the data received by said receiving device.

5. A method according to claim 2, wherein said information further comprises,
a property key indicating the property of the user using the transmitting device.

6. A method according to claim 2, wherein said information further comprises,
a secret only known by said transmitting device and said central service.

7. A computer readable medium having stored therein instructions for causing a processing unit in a transmitting device to execute the method comprising:
adding a transmitter token to said data before transmitting said data, said transmitter token being unique for said transmitting device.
